(19) United States
(12) Patent Application Publication
(10) Pub. No.: US 2013/0151970 A1
(43) Pub. Date: Jun. 13, 2013

(54) System and Methods for Distributed Multimedia Production

(71) Applicant: Maha Achour, Encinitas, CA (US)

(72) Inventor: Maha Achour, Encinitas, CA (US)

(21) Appl. No.: 13/679,893

(22) Filed: Nov. 16, 2012

Related U.S. Application Data
(63) Continuation-in-part of application No. 13/283,575, filed on Oct. 27, 2011, now Pat. No. 8,341,525.
(60) Provisional application No. 61/493,173, filed on Jun. 3, 2011.
(60) Provisional application No. 61/498,944, filed on Jun. 20, 2011.
(60) Provisional application No. 61/514,446, filed on Aug. 2, 2011.
(60) Provisional application No. 61/626,654, filed on Sep. 30, 2011.
(60) Provisional application No. 61/643,493, filed on May 7, 2012.

(51) Int. Cl. H04N 21/854

(52) U.S. Cl. CPC H04N 21/854
USPC 715/723

(57) ABSTRACT

A digital multimedia platform available to a plurality of collaborators of a video project through a networked computing system maps script information to a timeline, allowing contributions to be mapped to the timeline for inclusion in the project. One embodiment includes a tools module, an authentication module, a compilation module, and a script writing tool. The tools module enables editing of a multimedia project by collaborators. The authentication module assigns roles and privileges to collaborators. The compilation module receives files and information from collaborators to the multimedia project. The script writing tool implements edits to a script file associated with the multimedia project.

### REFERENCE RELATED APPLICATIONS

This application claims priority benefit of U.S. patent application Ser. No. 13/283,575, entitled SYSTEM AND METHODS FOR COLLABORATIVE ONLINE MULTIMEDIA PRODUCTION, filed 27 Oct. 2011, now allowed; which claims priority benefit of the U.S. Provisional Patent Applications listed below:

1. U.S. Provisional Application Ser. No. 61/493,173, filed on 3 Jun. 2011, entitled System and Methods for Distributed Multimedia Production, Maha Achour and Samy Achour, inventors; and

2. U.S. Provisional Application Ser. No. 61/498,944, filed on 20 Jun. 2011, entitled Systems and Methods for Distributed Multimedia Production, Maha Achour and Samy Achour, inventors.

3, U.S. Provisional Application Ser. No. 61/514,446, filed on 2 Aug. 2011, entitled System and Methods for Collaborative Online Multimedia Production, Maha Achour and Doug Anarino, inventors.

4. U.S. Provisional Application Ser. No. 61/626,654, filed on 30 Sep. 2011, entitled System and Methods for Collaborative Online Multimedia Production, Maha Achour and Doug Anarino, inventors.

All of the above-listed patent documents are incorporated herein by reference in their entireties, including figures, tables, claims, and all other matter filed or incorporated by reference in them.

### FIELD OF THE INVENTION

This disclosure is related to the field of collaborative online video production applications, and in particular, a multimedia system for video productions with embedded script and commands.

### BACKGROUND

Many of today's multimedia tasks are performed using audiovisual capturing tools to generate content that is then fed to expensive and sophisticated centralized editing and composing systems for titling, sequencing, super-positioning, effects generation and rendering before final release. Such a centralized approach discourages distributed multimedia production techniques and do not facilitate content feeds generated by professional and amateur entertainers, artists, media creators, and producers distributed across the globe. This is particularly the case with current video production systems where the script is a manuscript separate from the video creation process.

By using conventional video editors to implement an online video production application, the production team tasks are not balanced among users as the editor bears the most challenging and time-consuming tasks. Additionally, the production crew still needs to be present during video shoots. For instance, editors typically perform a variety of tasks in processing videos uploaded by crew members, including, but not limited to, (i) remove the green or blue screen and smooth the edges trim the video and adjust the video length in compliance with the script and/or producer/editor requests; and (iii) identify each video and associate it with its corresponding scene or shot within the video editor timeline.

With the emergence of online video content distributions, many amateur artists have attempted to produce their own videos using hardware and software tools available to them. Such approaches not only require having access to these systems and learning how to use them but also require that all video elements—from actors and background setup to sound and effects—be present in the same location and at the same time. Such stringent requirements are difficult to accommodate when scriptwriters, producers, actors, cameramen, stage artists, and musicians are working asynchronously wherever they happen to be at the time. Hence, there is a need for a systematic mechanism by which videos are seamlessly placed directly in the video editor timeline after removing the green and/or blue backgrounds. Similarly, multiple users may decide to collaborate in real-time on complex scenes, layered storyline, or live feeds. Furthermore, mobile applications of this novel web application (App) may be downloaded on mobile devices to notify users about a new or ongoing video production in their current geographical locations to upload specific videos, background screen, news shots, sounds, music, cover events, collaborative storytelling, and so forth. Or, users may initiate a production triggered by advantageous situations. For example, major news, social, or personal events in specific location will notify all or pre-selected users using such mobile app to collaborate on scripting, shooting, editing, and producing videos on the fly.

### SUMMARY OF SELECTED ASPECTS

Online video production that incorporates collaboration, script writing and video editing provides an end-to-end cloud video production tool for collaborators to produce quality and creative videos quickly and economically. In some embodiments, cloud video production may be assisted by mobile devices which communicate on-location information to the cloud production environment. In some embodiments, cloud video production may be assisted by on-location Hubs and related applications, hardware, and services to enhance and enrich video quality and content to further increase end-users and viewers engagement. Such Hybrid web applications may include modules for script writing, production collaboration, generation of: screenplay, storyline, script, lyrics, video, image, “voice over” functions, audio and/or music (including uploads), and/or soundtrack, as well as a full suite of editing and rendering videos. Various examples may include a combination of these, such as a subset of these functions, or may include additional functions consistent with collaborative production. Application users may include video producers (amateur, professional, business owners, marketing), editors, writers, actors, artists, singers, musicians, teachers, cooking chefs, business owners, and/or head of marketing departments.

The collaborative aspect of cloud video production may include applications, scenarios, tools and system architectures, such as those described herein, in some applications, subsets of these tools are used to produce varieties of videos which may be tailored to special and general audience—such integration may be accomplished using custom or general web and mobile Application Programming Interface (API).

### BRIEF DESCRIPTION OF THE FIGURES

FIG. 1 illustrates a Distributed Multimedia Production (DMP), according to some embodiments.

FIG. 2 illustrates a table of various camera locations with respect to an actor's positions and the corresponding angles, scenes, layers, according to some embodiments.

FIG. 3 illustrates an example of a hierarchy between application and user interfaces, according to some embodiments.

FIG. 4 illustrates an example of various elements within a shot, according to some embodiments.

FIG. 5 illustrates an example of a functional block within a main application page, according to some embodiments.

FIG. 6 illustrates an example of various functional elements within a user's idea page, according to some embodiments.

FIG. 7 illustrates an example of a functional block within script page, according to some embodiments.

FIG. 8 illustrates an example of a functional block within an Editor (or Director) page, according to some embodiments.

FIG. 9 illustrates an example of a functional block within an actor page, according to some embodiments.

FIG. 10 illustrates an implementation example of a script within a video editor, according to some embodiments.

FIG. 11 illustrates an example of a file Uploader with Chroma keys to illuminate green or blue background color, according to some embodiments.

FIG. 12 illustrates an example of a Filer Uploader assigning uploaded videos to target shots within an embedded script in a video editor, according to some embodiments.

FIG. 13 illustrates a method for producing a multimedia project, according to our embodiments.

FIGS. 14A and 14B illustrate a script writer tool and intake tool, according to an example embodiment.

FIG. 15 illustrates a video editor tool, according to an example embodiment.

FIG. 16 illustrates a mobile device display, according to an example embodiment.

FIG. 17 illustrates a stadium and location of collaborators as well as the information displayed in the video production editor.

FIG. 18 is a schematic view of a green green/blue setup where a subject is imaged using a green/blue chroma-keying light source and retroreflective backdrop.

FIG. 19A is a schematic view of a green/blue screen setup where a subject is imaged with only the retroreflective backdrop.

FIG. 19B illustrates the chromakey retroreflective which includes a chromakey paint and glass beads.

### DETAILED DESCRIPTION

Presented herein is a novel platform that alleviates such requirements by opening up the video creation, production, and distribution process to a collaborative process. Such methods and applications may be used to democratize digital video processes and thus empower a whole new generation of artists, writers, content, and markets by exponentially increasing the number of professional and amateur video creators and industry players contributing to the whole video digital content and economy. Unlike conventional online video editors, online video production communities using this novel web application have interaction with script writers. Hence, the script is seamlessly embedded into the video editor to simplify the production process and balance production roles among users. Eventually, diverse global user communities may be formed that include a variety of participants, such as students, writers, actors, cameramen, artists, filmmakers, musicians, educators, journalists, travelers, activists, sports enthusiasts, and bloggers. Such a novel production environment enables practically anyone who wants to create original video content. Furthermore, the script may encompass placeholders, command lines, and producer editor comments to automatically upload videos captured by socially connected users into the pre-assigned slots in the video editor timeline to enable collaborative storytelling and make video production a social experience. These users may do so by using the App version on their mobile devices. Such novel platform creates aggregate value by offering an environment for collective efforts and collaboration instead of today's tiny and disconnected individual efforts or expensive and inflexible production studio styles. This “Community-Driven” web application also brings together amateur, professionals, and celebrities, where feedback or cameo appearances by celebrities and professionals may be the ultimate reward to amateur users.

A mobile App has both client side portion and software on network servers which receive a plurality of video, audio, images, commands, text, and comments data streams from a plurality of mobile stations to produce videos on the fly or in a time delayed fashion.

Users may select to keep copies of their own files on their mobile device.

Unsophisticated users may configure their mobile App from a pre-selected menu to setup the complete or a portion of the simplified video production portal application from both the client and server sides depending on their roles in the production process.

For instance, a football event may trigger a video project where users are scattered around the football field. Production owner uses the script tool to create scenes and shots using script tool, where scenes my represent the quarters in the game, introduction, summary, best plays, highlights, key players, and so forth. Actors are now cameraman using their mobile devices to follow the script. Mobile App will be configured based on their role and will allow them to simultaneously view video shots to interchange roles on the fly depending on game progress.

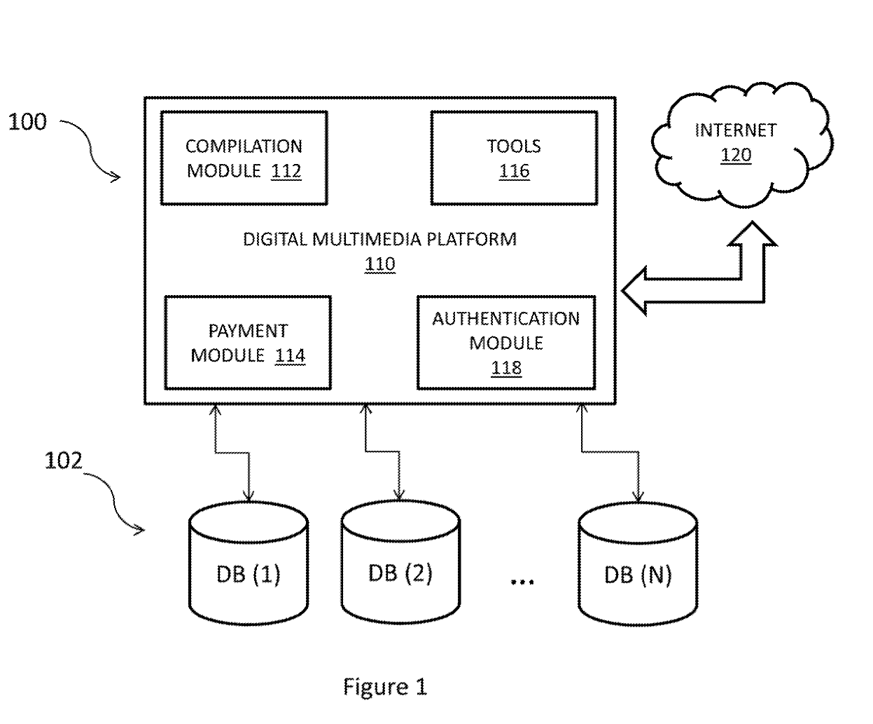

In some embodiments, a system 100, as illustrated in FIG. 1, includes a Distributed Multimedia Production (DMP) platform 110 communicatively coupled to the Internet 120 and one or more databases, DB(1), D(2), . . . , DB(N) 102. These system elements may be distributed among a collection of servers located around the globe. The configuration of system 100 allows collaborative processing incorporating multiple distributed participants. The DMP 110 enables a new generation of socially-connected professionals and amateurs to collaborate on high-quality video productions. Participants are able to work together in the process of generating the video, as well as to make the resultant work available online and accessible to mobile devices. The collaborative and distributed type web applications described herein provide online tools to write scripts, add commands, shoot videos, edit, produce, market, and distribute quality videos in a systematic, flexible, seamless, and simple way so as to make each user's experience enjoyable, rewarding, and exciting.

In one example the DMP platform 100 is a collaborative web application having modules for compiling a composition, authorizing users, providing tools to users, and payment or subscription processing. Other modules may be added as a function of the capabilities and desires of the collaborators. The DMP platform may be implemented as a cloud service, where functions are provided as a networked solution. The DMP platform may be implemented as distributed modules, where software is downloaded or otherwise provided to the collaborators.

The modules of DMP 110 include tools 116 which provide applications and utilities for each of the users. These tools 116 will typically include tools specific to the functions performed. In this way, tools 116 may include a set of tools for authors, a set of tools for videographers, a set of tools for editing, a set of tools for compilation, and other functions. The tools 116 may further provide access to other applications which are not included in the DMP 110 but are available through a networked connection, such as Internet 120. In some examples, participants are able to access external applications and tools, such as third party applications or Tools as a Service (TAS) applications, whereby, tools 116 may interface with Application Programming Interfaces (APIs) seamlessly. In this way, the participant may select the feature or application desired, and tools 116 will set up the connection automatically and allow access to the application.

Users may access tools 116 according their role or identify, as well as according to the production arrangement. The tools may be provided as services or may be downloadable as widgets for use at the collaborators computing or mobile device. The tools 116 may further provide interfaces and APIs to the user for interfacing with external devices, such as cameras, lighting equipment, sound equipment, digitizing devices, website, other resources and software programs. The tools module 116 may further provide drivers for control of external devices and software desired for use on the collaborative project. The tools module 116 maintains these various mechanisms and works in cooperation with the other modules within DMP 110, such as the authorization module 118, compilation module 112, and payment module 114.

The compilation module 112, according to some embodiments, allows users to build the multimedia work by compiling the various components generated and contributed by each of the collaborative users. The compilation module 112 processes uploaded files and video to allow fast online processing. For instance, characters, scenes, shots within scenes, commands, dialogues, actions, and comments are created and included during the script writing process to build videos initial structure. Such structure is automatically integrated into video editor timeline. Comments may be part of the shot metadata that users, specifically actors and cameraman, can input to describe building blocks of elements used to create the scene such as type of furniture, clothing, jewelry, accessories, and so forth, to enable viewers to select these items while watching the video to determine vendors selling these items online, in stores, or in nearby stores depending on user's location. This embedded advertising becomes part of the revenue models for this novel web application. Furthermore, high-quality videos are converted to low-resolution files during the upload process to enable users to edit them on the fly, green or blue background screens are automatically removed, and videos are trimmed to assign each trimmed video file to its corresponding slot in the video editor timeline After the video editing process is complete, the compiler renders the video to its original high quality resolution for online, broadcast, or cable distribution. Information included in the script, such as characters, scenes, shots within scenes, commands, dialogues, actions, and comments, may be integrated with the video during the rendering process to provide keywords and descriptions that may be used to promote the video, associate relevant commercials and advertisement during viewing, and help search engines identify clips within the video. This data may be stored in a new format with the video data, or may be stored in a separate file mapped to the video data. A web application may include HTML and style sheet documents, which provide the graphics and look of the webpage, which are downloaded to user? drive and cached. It may also include text files, which are validated by the browser, such as XML, java, flash or other files. The authorization module 118 identifies users by identity, such as by roles or contribution, and applies rules for processing and enabling operations. The authorization module 118 assigns and monitors rights are based on a processing scheme. In some embodiments the processing scheme is predetermined prior to starting a collaborative project or work. In some embodiments the processing scheme may be dynamically modified by an administrator. The authorization module 118 works in coordination with the payments module 114 to bill participants and to verify payment for each collaborative process according to the processing scheme. The payments may be based on collaboration parameters, such as by data content or by time used. Further, the payment module may enable a profit-sharing or other arrangement. The payments module 114 provides the payment status information to the authorization module 118; in response, the authorization module 118 may enable or prohibit users with respect to the various functions of the DMP 110.

The DMP 110 may be further offered as a cloud service, such as Software as a Service (SAS). In such an environment, the DMP 110 platform may upgrade the various modules without interruption or action by the users. The collaboration of users is then facilitated through the cloud service(s), enabling collaborators to work together asynchronously but with the most recent versions and information. The cloud service may access other information available through the Internet, and may also access proprietary databases of the collaborators. Where the service is provided as a platform or application in the cloud, the service is then available for easy access from any device having capability to access the Internet or network. The ability to collaborate from anywhere provides users with enhanced flexibility. Similarly, multiple users may decide to collaborate in real-time on complex scenes, layered storyline, or live feeds.

The DMP 110 may be used for Internet productions and publications, such as video and TV applications available at sites on the web. The DMP 110 is configured for use and communication with Internet protocols. The DMP 110 may post or publish video content and monitor its use and viewing statistics. This information may be used as feedback in further development of a given project or as survey type information for future projects. The DMP 110 may be used to create casting calls or review screen play snippets. This may extend to film festivals for coordination and planning of events.

Individual films may be created on or provided to the DMP 110, for review, scheduling and selection by a film review committee. In this scenario, the reviewers could provide critique and edits to the film, having ability to manipulate scene information. This is available as the project is configurable by the DMP 110.

### Some Examples of DMP Systems

In some examples, a DMP 110 eliminates costly tools, equipment and royalties by providing or recommending video capture kits with camera, microphone, green screen, lights, and so forth, as well as providing royalty free stock footage and soundtracks. The DMP 110 enables asynchronous shots taped by actors to be assembled into a single shot within a scene, in accordance to script information, to provide streamlined production processes. The production processes provides simple writing tools which expands an idea to a detailed screenplay. Further, the DPM 110 provides powerful editing tools to layer video elements, incorporate and modify video and audio elements, title and subscript scenes, add effects and transitions into a high-quality video production. Similarly, multiple users may decide to collaborate in real-time on complex scenes, layered storyline, or live feeds.

In one example, social networking tools allow writers, producers, actors, cameramen, and artists to collaborate and share work at any stage using a computing or mobile device. Such a collaborative platform may be used to create videos including short videos of offbeat comedy skits, spoofs, training videos, commercials, infomercials, documentaries, full length movies. In same examples these collaborations may produce videos of short duration, less than ten minutes, or long durations. The collaborative platform accommodates multiple contributors. A producer, writers, editors, actors, cameramen, artists, musicians, sound engineers, and others may all participate and contribute at different stages of the video production. The roles of the participants may include producers, writers, actors, cameramen, engineers, editors, and so forth.

In some embodiments, a producer is an authenticated owner of a particular production having ultimate control over its metadata, access rights, scene releases and credits. The producer may post a call for writers, actors, cameramen, or others for the project. The producer selects and authenticates writers, actors and other participants. Writers are authenticated users granted access to a page for editing the script, referred to as the Edit Script page, for a particular scene or all scenes in a production. There may be multiple writers for a single project. The writers may have a partition that allows them to collaborate among themselves prior to posting their writings for viewing, critique, and learning by others. Once the writings are so posted, an editor or producer will review, comment and revise the writings. Script may include characters, scenes, shots within scenes, commands, dialogues, actions, and comments. An editor is an authenticated user granted access to a page for editing the video, referred to as the Edit Video page, for a particular scene or all scenes in a production. The actors then act out the writings, or script; the actors are authenticated users having a defined character role in a particular scene and therefore are granted access to a page to upload clips, referred to as the Upload Clip page, for that scene. Actors may include celebrities providing cameos which may be integrated into the video project. An artist is an authenticated user given the task to generate background images and videos for given scenes when directors/editors cannot identify suitable ones in the application database. Engineers and musicians are authenticated users given the task to generate sound effects, video effects and music for given scenes when directors/editors cannot identify suitable ones in the application database. Administrators are DMP personnel having access to certain editorial functions. Super Administrators are DMP technical personnel having access to user accounts and low-level functions, as well as having control to configure the DMP according to a processing scheme.

When a production is first created, its producer (or potentially the owner) has access to many functionalities, including multiple access rights, but they can also assign those rights to other users. The access rights include:

a) Script Viewing: ability to view scene scripts (can be public).
b) Commenting: ability to comment on scenes
c) Script Writing: ability to create scenes, shots within scenes, and edit their scripts and character roles, add commands, dialogues, actions, and comments.
d) Editing: ability to sequence uploaded clips, add effects, titles, transitions within the editor
e) Upload: general file upload rights, which may include green or blue background removal, video trimming, and linking files to their corresponding slots within the video editor timeline
f) Casting: ability to assign users to character roles

The DMP 110 supports a variety of processing functions, some of these are detailed below according to an example embodiment.

### Script Editor

This function is based on the type of user and currently selected element. Below are few of the types of script elements supported:
1. Shot—a single camera angle
i. Horizontal slider: angles from −90° (left) to 90° (right)
ii. Vertical slider: angles from −90° (down) to 90° (up)
iii. Depth of View slider: values −10 (wide angle) to 10 (closeup)
iv. Transition to next shot (optional)
v. Suggested length: auto checkbox allowing override of length field only if this scene has not yet had its video edited
2. Action—direction for movement of a single actor
i. Character selection menu
ii. Start position selector (clockface)
iii. End position selector (optional)
3. Dialog—lines to be delivered by a single actor
i. Character selection menu
ii. Delivery extension field
4. Command and comment lines
i. Placeholders for videos uploaded by social media users
ii. Marketing material
iii. Users comments

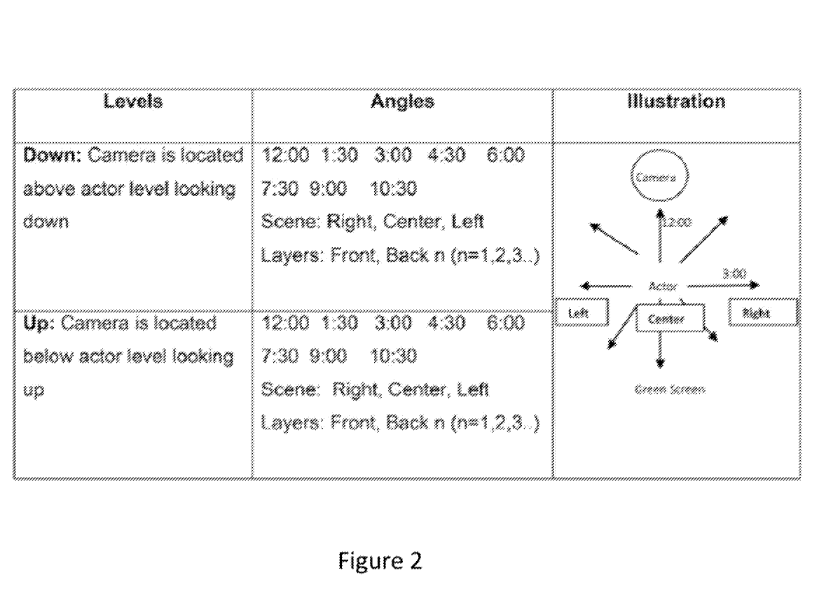

Lighting settings may be set in a similar way without being the same as actor/camera settings. FIG. 2 illustrates a table depicting an actor's positions and angles with respect to their own camera/green screen and to each other. Such guidelines may be integrated with the script to facilitate the video production process.

In developing a production, a script writer may include additional fields to enable seamless integration with video editor and to allow actors to easily determine how to shoot and time their videos. FIG. 2 illustrates an example scenario of a frame 200 having multiple fields.

A timeline track displaying information from the script alongside the actual clips being tied together may be used as a control, but moves in tandem with the actual time line content as its zoomed and scrolled (like the Ruler control). For instance, an editing panel may appear when a shot clip is selected in the timeline, offering the following elements:

1. Background continue toggle allows for the background clip from the previous shot clip to just be continued
2. Background drop well, visual clips can be dragged here to indicated background if toggle is selected
3. Character menu lists characters appearing in the selected shot and controls content of the elements:
a. File selection media browser displays just the takes uploaded by the character's user or this shot, so one can be selected
b. Layer button set offers ability to send character frontwards, backwards, to the front or to the back
c. Trim control allows trimming of selected file from beginning or end
d. Offset control allows incremental resequencing of selected file
e. Hue, saturation, contrast and brightness slider controls
f. Position control allows character to be moved onscreen

g. Resize control allows character to be sized onscreen

### New Functionalities and Payment Scenarios

The collaborative online video production application and its associated payment stream models. These new types of online payment streams are based on the application ecosystem ranging from the collaborative environment, video content, talented users, target audiences, to partners. In some embodiment, the payments module 114 calculates fees for accessing talents promoted by the application. Access may be by internal or external users/consumers. For instance, a producer may want to hire a video editor, script writer and actors to manifest their vision for a production. The payments module 114 may further incorporate a payment transaction charge as a flat rate, one-time payment, royalties, or a full license to the application. Subscriptions may be implemented to provide different rates to groups and video production channels of relevance to the consumer. A reward program may be implemented by ranking videos and types of users. A reward program may consist or linked to points collected by users depending on their contributions and or revenue generated by their videos. In one embodiment the DMP 110 matching users with each other or with the consumer, branding videos to further promote very successful (viral) videos.

The DMP 110 may be used for engagement and interactivity with the audience, such as fans, sponsors, partner, and so forth. The system 100 further allows for partnerships with third party distributors, vendors, and services. The DPM further provides expanded access to royalty-free stock content library and to effects, transitions, themes and so forth.

Some embodiments implement transaction fees for payment transfers between accounts. Advertising may be displayed on the DMP site and in correspondence, with the ability to block ads on the site and in correspondence. Advertising returns may be applied by the payments module 110 where site content is displayed or otherwise used on third party sites and services, and wherein the ability to retain or regain ownership of user content is provided through the DMP 110. Further, the DMP 110 may be used to account for and process hosting fees for podcast channels

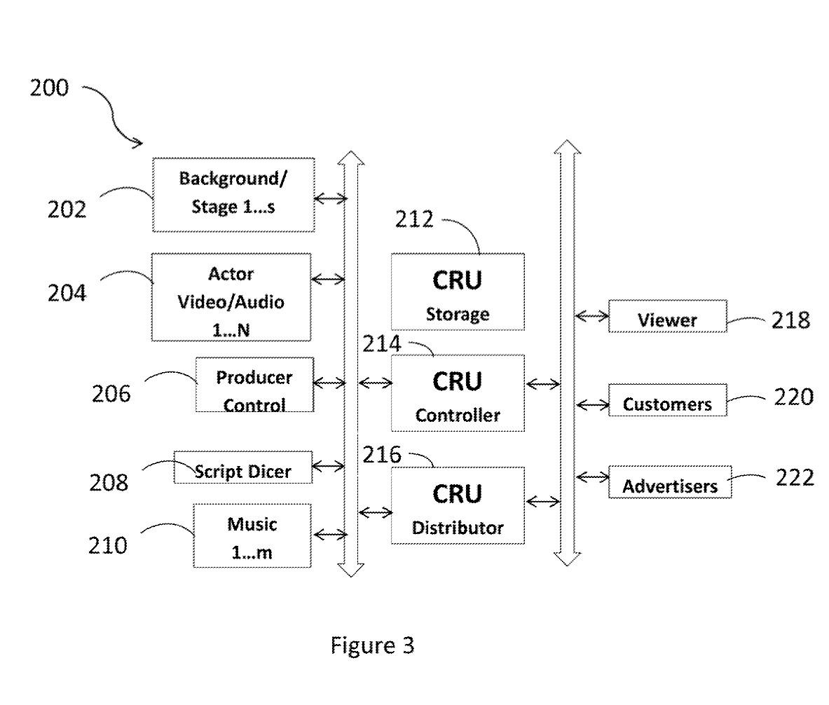

The following describes a video production system 200, illustrated in FIG. 3, which distributes video production so as to satisfy requirements of collaboration among script writers, producers, actors, cameramen, stage artists, and musician are scattered all around the globe and may be unaware of each other's presence. In this embodiment, an online produCtion of distributed mUltimedia tool referred to as a CRU or CRU tool, alleviates many of the video production challenges by opening up the video creation, production, and distribution process to a group of users, and may even open the process to the general public. The CRU tool democratizes the digital video process to empower a whole new generation of artists, writers, contents, and markets by exponentially increasing the number of professional and amateur video creators and players contributing to the whole digital video content and economy. The CRU platform 212 includes a variety of elements and functionalities. As illustrated in FIG. 3, the system 200 includes multiple CRUs 212, 214, 216, each coupled to multiple environments. The CRUs are coupled to environments including a viewer interface 218, customer interface 220, and advertiser interface 222. The CRUs are further coupled to a production environment including a variety of elements and functions.

One production function is referred to as the Script Dicer module 208, which enables script writers to enter their scenes, lines, storyline in a creative, collaborative way to enable actors and producers/directors to seamlessly assemble the video. Such script dicing includes, but is not limited to, tagging/linking each scene, actor line, location, time. Another production functionality is the Actor Video/Audio Captor module 204, where each participating actor is offered a toolkit used to homogenize the scenes. These kits may be provided for under a variety of scenarios, including for fee or as part of a complementary software development kit. Such kit may include a green/blue/unicolor background screen, microphone, video capturing camera, and/or an illumination light source. Depending on the scene, actors may be given guidance on how to position the camera and illumination source. The actor toolkit may include a driver to seamlessly interface with the CRU cloud.

The Producer/Director Control module 206 functionality component of the CRU platform enables a producer/director to integrate all video elements by making associating actors, cameramen, background video or images, and music to each scene before final editing and production.

Another production function is the music module 210 that enables a musician to upload, create, and edit the soundtrack that is suitable to video scenes. It also includes a database of music tracks from which to select. Such music tracks may be labeled/tagged, and are not necessarily limited, by type, instrument, length, modularity, genre, and so forth.

Still another production functionality is the Background/Stage module 202 which enables photographers, cameramen, artists or amateurs to upload, create, and edit static, animated, or videos suitable for scene background. It also includes a database of such material from which to select, such as when a unique background is not desired. Such background images/videos are labeled/tagged, but not necessarily limited, by type, day time, size, duration (such as for videos), modularity, and genre. Many factors are considered when combining actors' videos with background scenes to homogenize the video. For instance, lighting and camera angle are some factors that are typically taken into consideration during selection and integration process. The system 200 allows artists and amateurs to upload their images and videos using different angles or 360 degree viewing capabilities as it is the case of three dimensional maps.

The system 200, including CRU platforms and services, brings the collaborative video making experience to multiple people without requiring them to go through years of education and experience to penetrate such industry and create new industries based on the creativity and free exploration CRU users enjoy on an individual basis or collectively.

With the proliferation of social networks and video sharing and distribution sites, the systems 100, 200 allow amateur online users to quickly, seamlessly, and collectively combine their ideas and concepts to produce the target video production. In some embodiments a master and slave node hierarchy is used to balance control between online users.

A master user has the responsibility to invite participants, assign roles, and oversee content capturing and production processes. Each user is able to see all contents generated by users in real-time or archived, but only master note is capable of activating a subset of users to interact on given scenes of the video.

In these collaborative systems, a set of tools may include a green/blue background, video/audio capturing mean such as video camcorders, software interface an drivers. The user interface is a Graphic User Interface (GUI) and hardware interfaces which are linked to the CRU.

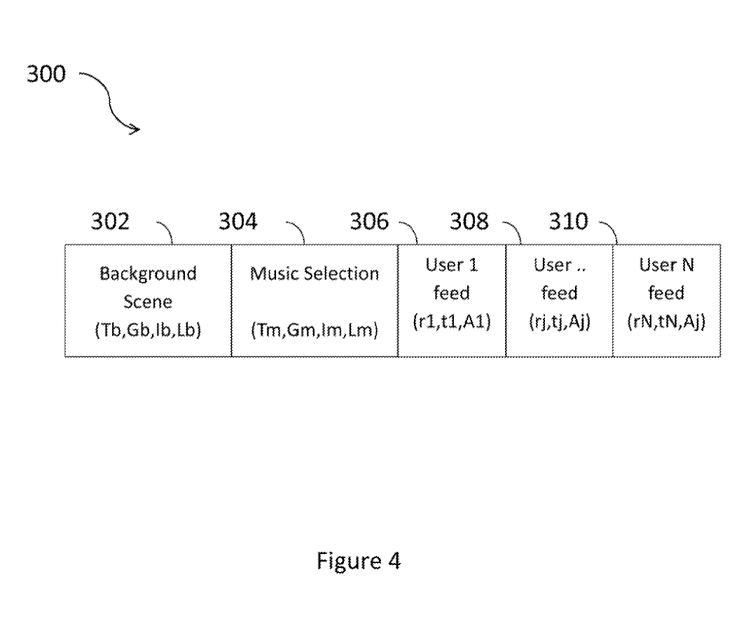

FIG. 4 illustrates the various video elements according to one embodiment, where variables represent the parameters and features of the video. The video elements are specified by field structure 300 including background field 302, music selection field 304, and user feed fields 306, 308, 310. The Tb/Tm represent the type of background and music; the Gb/Gm represent the genre of the background and music; Db represents anytime of background music; Im represents instruments; Lb/Lm represent duration of background and music; rj represents position; tj represents a time stamp; Aj represents angle and illumination of jth actor. The type of background is identified by the variable Tb. Types of backgrounds include static images such different angles of office or restaurant areas, or video background such as moving car or beach scenes. The type of music is represented by the variable Tm such as suspense, cheerful, sad, or sound effects. The genre, represented by the variable G may include comedy, drama, horror, action, documentary, newsfeed, storytelling, sports, social, or kids. The instrument(s) used in the audio are represented by I. The duration of the background scene or music is represented by the variable L. The position of the actor within a shot is represented as rⱼ′; and the time stamp is represented as tⱼ. The angle and illumination of a jth actor, with respect to a reference is represented as Aⱼ. This scenario enables multiple users and allows these users to upload video files.

Editing, integrating, and rendering online video may be accomplished by reducing video quality during the upload process, using distributed servers that process and run specific or general editing, integrating, and rendering requests to recover original video quality. In one embodiment a CRU video editor includes a unique feature that dynamically adapt the video capturing and illumination angles of the different videos that will be eventually combined to create the final scene.

In terms of the services offered using CRU engine. Any user can initiate the video creation process, such as an amateur who can simply post their simple ideas. Such posting may also initiate an alert signal or message to script writers, directors, actors, cameramen, and musicians (other participants) interested in similar ideas to further advance the collaborative video process. Industry players looking to create commercials for their products can use CRU to create competition among users to create winner commercial.

Advertisers of products and services having a relationship to a particular video theme or genre, or desiring to make a connection with a particular audience, are able to advertise their products or services, and act as participants. By incorporating an advertising function provides a revenue stream for video producers. The CRU platform may be provided as a free service to all users at all levels. In some embodiments, users may search certain levels, such as actor, script writer, musician, director level after they achieve a particular goal. In one scenario, the goal may reflect successful accumulation of a number of points. This may be based on the number of released videos from a given user's contributions.

A CRU participant may advertise a video project on the social network(s), where their interest graph identifies potential participants. Social networks may also be used to advertise the video after completion. The CRU may incorporate its own video distribution channels as well as conventional hooks to social media. The CRU engine keeps track of CRU videos activities and revenue regardless of where they reside.

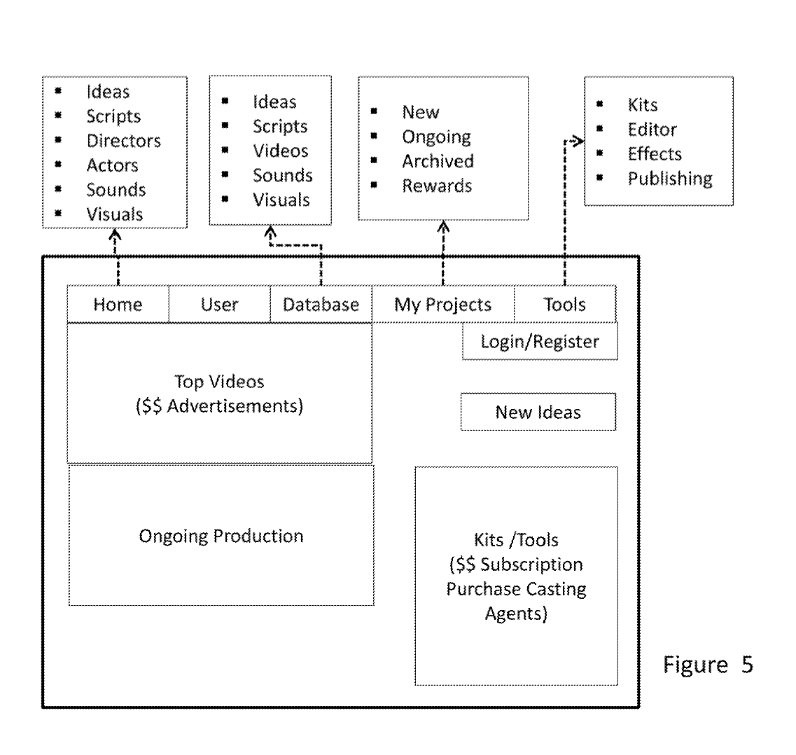

A CRU system may include an internal system to enable CRU users to monetize their contributions and develop a reputation within the CRU community. This will attract others and create groups of users active in the video production business. FIG. 5 illustrates the functional building blocks of a Graphical User Interface (GUI) expressed in a home page 500.

In this embodiment, the home page presents a variety of different functionalities for users. A user may share an idea to solicit interest from script writers, Directors, Actors, cameramen, musicians, sound effect, visual effects, or background scenes and videos. A user may further insert a screenplay script manually or dynamically by uploading script files. The user may select a role, as in selection box 502. For example, a user may select a role as a director, actors, cameramen, sound engineer, score composer, or music content creator, or artist creating visual effects, background images, videos, and so forth. In one scenario, a director allocates roles based on the script and has the right to modify the script at his leisure while notifying other project members, who also may provide their inputs to the script for the director's review and acceptance or rejection. In this scenario, the director receives the modifications and additions, but has the right to modify the script so as to avoid simultaneous or conflicting changes. Each actor may have multiple insertion points in a script in a given film. Additionally, the script may include lines that will be eventually filled by the actor during video shoots. For example, a director may decide to shoot the same scene using different angles or facial expressions and then decide which ones to use during editing.

A database of information may include multiple partitions, and is used for storing ideas, scripts, names of directors and actors, cameramen, sounds, visuals, which are selected in the this will be transparent to users as some of them will have access to view and utilize other projects contents, such as after paying a higher subscription fee. This fee may be shared with other users who produced these videos. These elements are accessed by selection of the database selection box 504.

On the homepage GUI 500, users can view cool videos, and then may be encouraged to either register or login to learn about how these videos are created. The homepage 500 further includes tools, accessed through a tool selection box 508. The tools are for development, editing, effects editing, publishing, and so forth.

Casting agents may also be given the opportunity to register and login to view the actor's audition videos and are encouraged to give feedback. Casting agents interested in communicating directly with actors may be asked to pay a fee to access such a service. Such payment scheme may assign fees to be collected when actors purchase their video kits. The kits may be part of the tools, and provided as a development tool kit. The video creation process is presented in a linear fashion, where the users may follow a plan to build the video, or participants may add their portions asynchronously, allowing the video to develop through an iterative process.

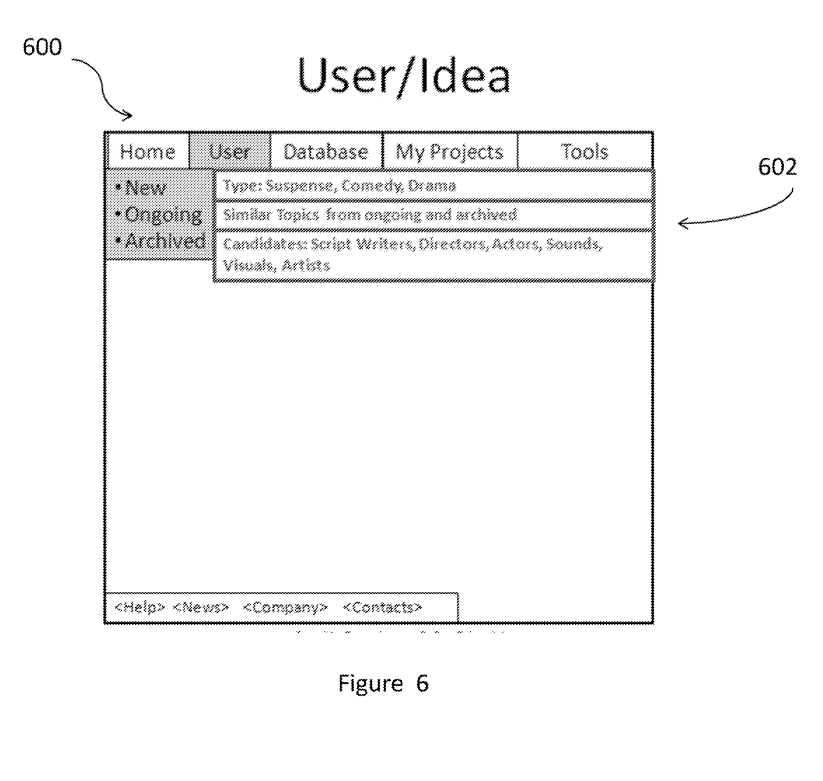

FIG. 6 illustrates a user GUI 600 for inputting an idea for a project. The selection box 602 identifies what type of project to create, whether it is a new project, or continuing an existing one. The user may also select from archived elements to configure a team to build a project.

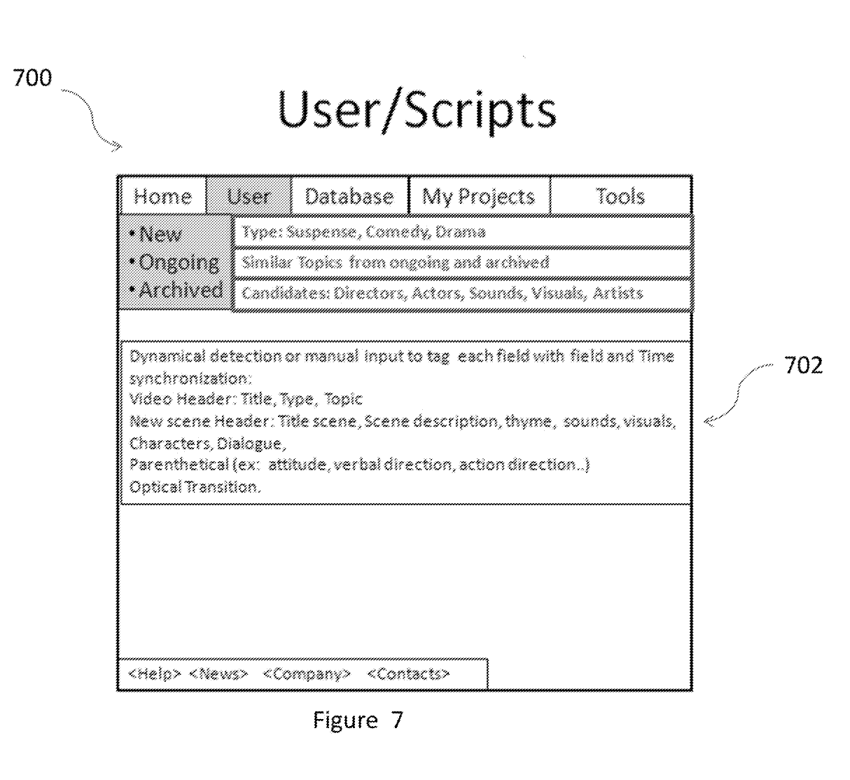

FIG. 7 illustrates a user GUI 700 for inputting script information. The script input box 702 may be an area where the user identifies the script specifics, or may be an area to upload a script created off-line. The script may be identified by standard or agreed upon format.

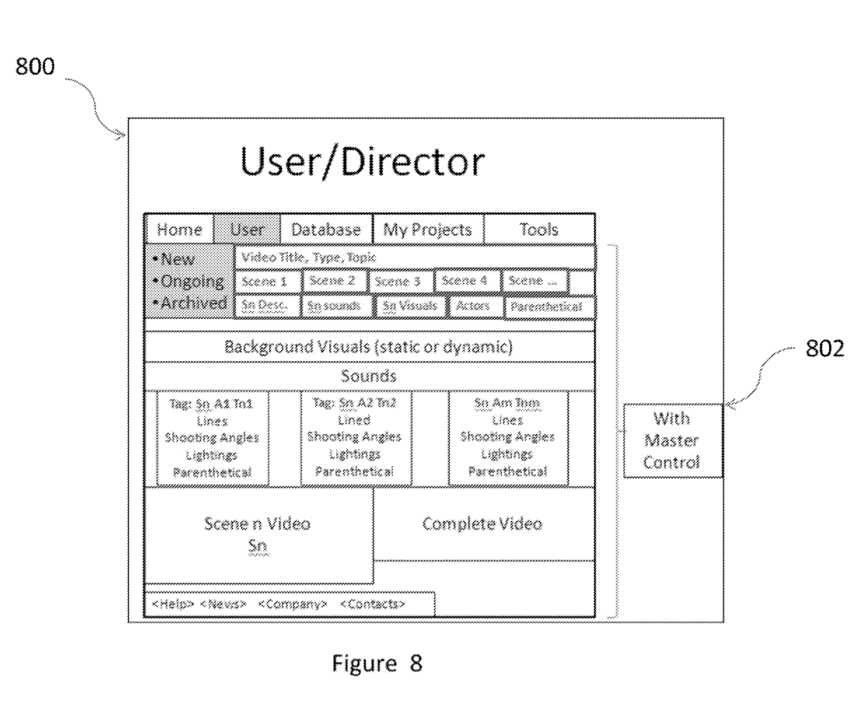

FIG. 8 illustrates a user GUI 800 for inputting director's instructions, guidance and notes. The director creates a group of insertion points. As illustrated, the director's GUI 800 identifies a group SnAlTnI that refers to actor Al in nth scene ore shot at time start TnI. The group is a collection of points that the director has created that will be filled by video of actors which may be filmed later. Actors and other project members can view the project at any time but may have no rights to modify contents except for their own contributions. The director acts as the master participant and has higher authority and control than other participants. Master control portions 802 identify those areas that are used to implement the director's decisions. The director will specify the particular components for each scene, as well as the participants and their roles. Director and editor roles may be identical in this novel online application.

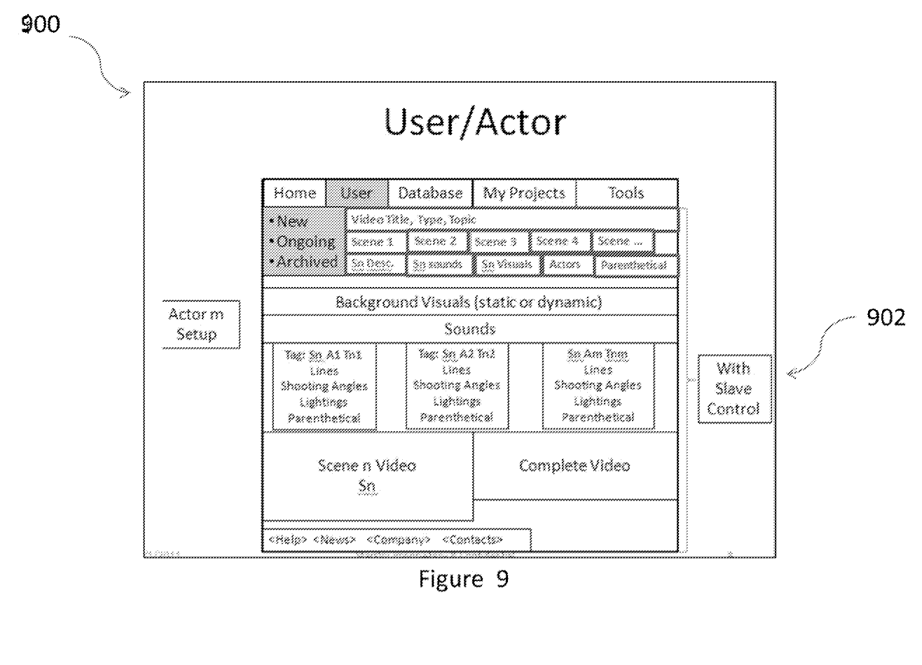

FIG. 9 illustrates a user GUI 900 where the actors may respond to control instructions of the director. The actor acts as a slave to the directions of the director. The slave control portions 902 identify those areas that actors use to implement the director's instructions.

Actors use the recommended video kit elements to record the different videos assigned by director. The GUI will guide them on where to position the light, camera, and other items such as fan, eyeglasses, item in hand. As illustrated in FIG. 9, the user GUI 900 presents options to the actor to select a scene, sounds, and so forth. This illustrates the slave mode of the system, which allows actions in response to the master. For voice over functions the user may play the video and add the voice when appropriate, such as in an animated project.

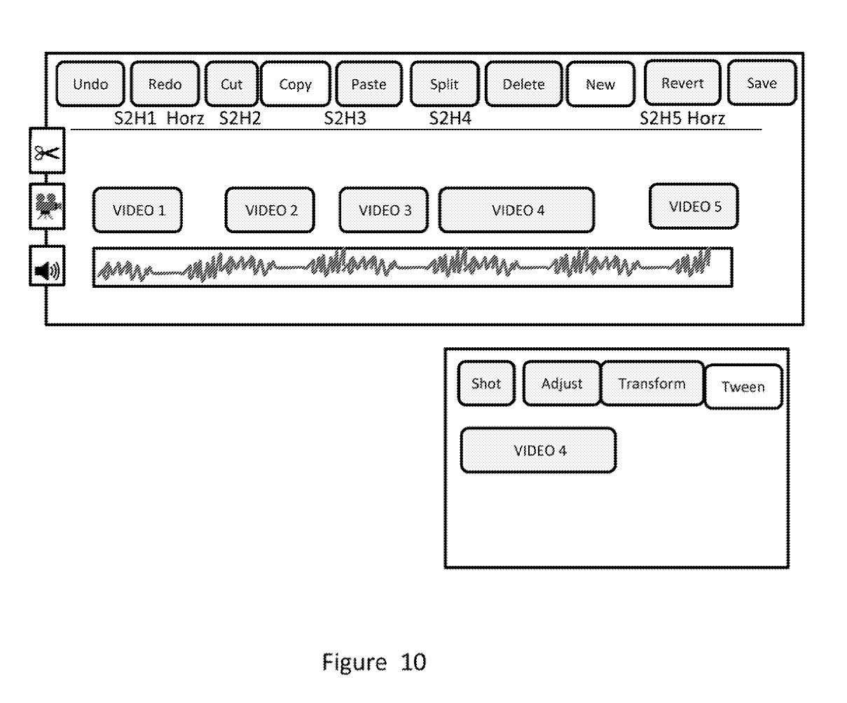

In one embodiment, illustrated in FIG. 10, a video project is put together to illustrate multiple video portions and application of the audio portions. Textual information may be provided to instruct actors are other participants. An “auto” button may be checked to allow the video editor to automatically adapt to uploaded video durations. Various fields may be used to label each shot as part of a given scene. Adjustment controls, such as horizontal, vertical, and deep sliders may be used to provide actors with desired shooting angles. In the present example, the camera is shooting horizontally from −14 degree angle and the shot duration is set to 1.8 seconds. The script dialogue, shots, and actions are embedded into the video editor.

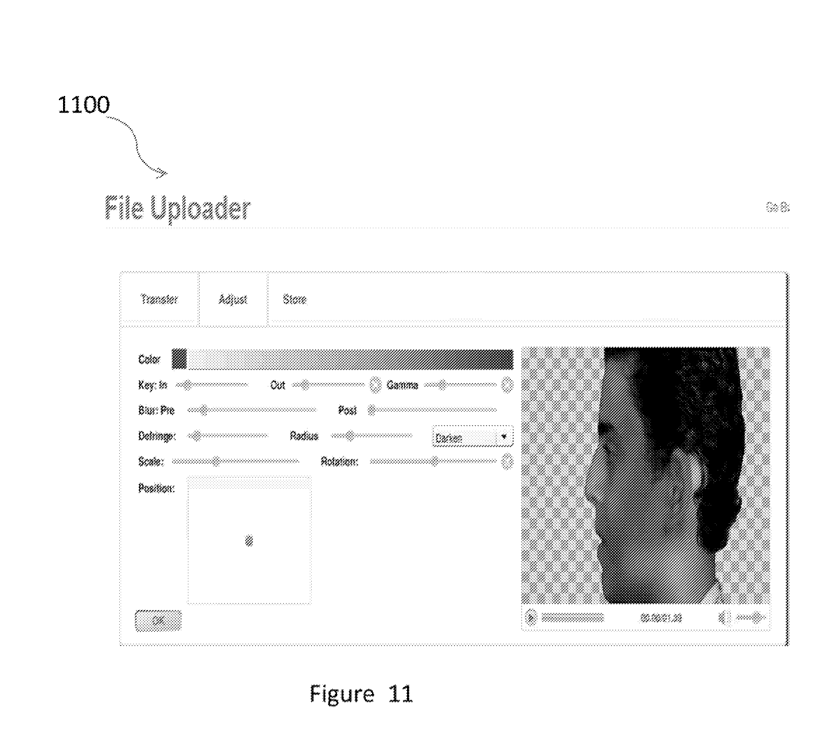

FIG. 11 illustrates one example of a video file uploader 1100 equipped with functionality to modify a green screen or blue screen. As illustrated, the uploader 1100 includes various sliders and adjustment mechanisms. The uploader 1100 may be used to remove the green or blue background of an uploaded video. In one example, a user may drag a color square along the green shade spectrum or along the video itself, and in this way, reduce, eliminate or adjust the green/blue color of the background. The video file uploader 1100 is adapted to upload a user's files where general files may be uploaded to video production general folders. These general files are added to web application general database. A user selects destination of files associated with a shot to include them in the corresponding script section in video timeline. A user is able to remove green and blue backgrounds of uploaded videos. A user is able to trim videos to comply with the script, and adjust according to a timeline. A user is able to edit videos and may upload video file that includes multiple shots while indicating start and end times of each shot or scene.

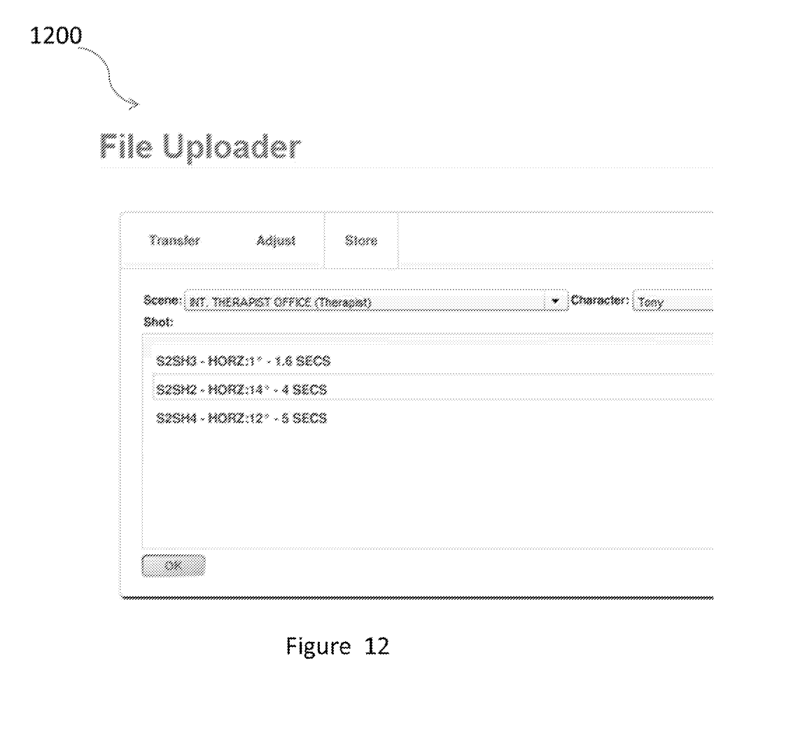

FIG. 12 illustrates the uploader GUI 1200 for storing the video. The uploader 1200 provides users with the scenes, shots, and character selection. The uploader GUI 1200 may include a variety of configurations, such as identifying the timing on a timeline for placement of the uploaded content.

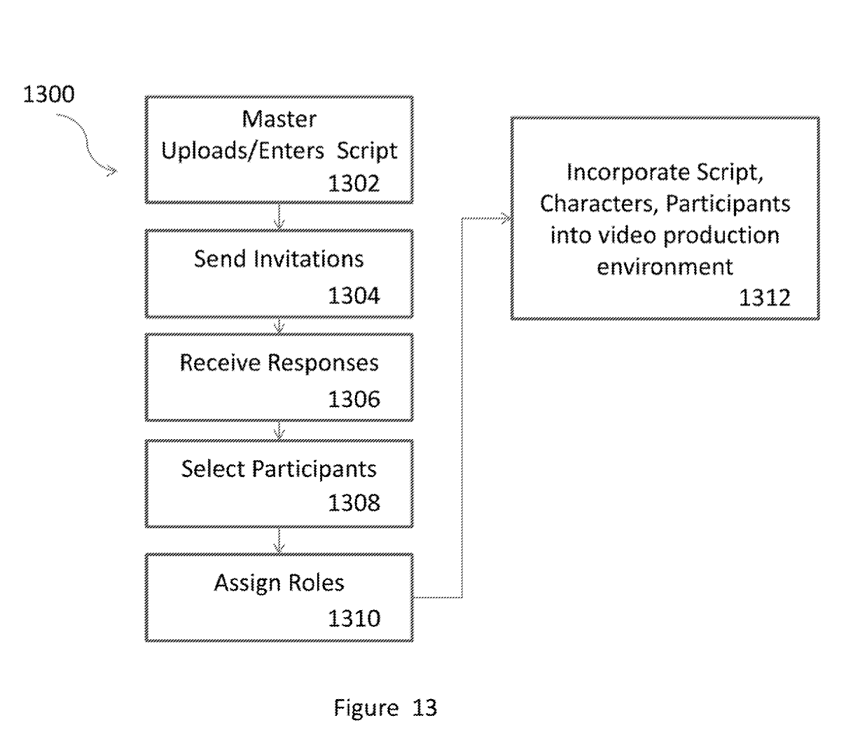

FIG. 13 illustrates a method for generating a multimedia project according to an example embodiment. The method 1300 starts with a new video idea or master uploading or entering a script, operation 1302. The uploading may be done by a user initiating a project or may be in response to a request received from a director or other project initiator or owner. If the script is uploaded, the system works to extract script component information and apply this information to a timeline for the project. The extracted or entered components may include scenes, shots within scenes, commands, comments, characters, characters assignments, dialogue and character lines. The participant may then send out invitations to potential or desired participants, operation 1304. The invitations may be posted on a designated website, may be sent out to individuals through email, social network, professional network or other community communication network. These invitations may be to fill specific roles, such as characters, and may also be for technical editors, video editors, script writers, photographers, and other roles needed for collaboration on the project. Responses are received through the system, operation 1406. The participant may then select other participants from the responses received, operation 1308. The participant may request further information, similar to auditions, so as to complete the selection process. The process then assigns roles, operation 1310. The collaboration is then incorporated into the multimedia production environment. The script is effectively overlaid on a timeline and characters per scene are placed at the time when their action occurs. This allows collaborators to add their contributions to the correct position in the project. In one embodiment, the script is tagged and the components each have a unique identifier. When other collaborators build and create content and contributions, the systems tags these so that they are seamlessly added to the project. In this way, video for a given scene or corresponding shots is uploaded and mapped into the project at the correct slot in video editor timeline. In some embodiments, the user merely posts the contribution to the project and the system reads the contribution tags and incorporates according to the tag. Tagging allows the system to automatically perform steps that were done manual in previous systems and solutions. This allows the system to incorporate script components into the video production environment or other multimedia production environment.

In these and other embodiments, a video production web application incorporates a collaborative environment providing invitations to participants, similar to a call for papers or review in an academic setting. The invitation may be provided to a designated group or to a general public audience. The master initiates a session by uploading or incorporating a script to the system, thus triggering an invitation mechanism to invite users to participate in video application. The script may include characters, scenes, shots within scenes, commands, dialogues, actions, and comments. The Invitation is sent to potential participants. This may involve sending an email to a user account, or to a social media contact. In one embodiment, the invitation is posted for review and acceptance by multiple potential participants, such as posting on a social media site. For example, a director may assign the producer role to a video production owner, who then selects crew from respondents. The producer then assigns roles to individual participants selected from the respondents. If there are no satisfactory respondents, then the producer or master may send out a specific invitation to one or more desired participants to fill a role.

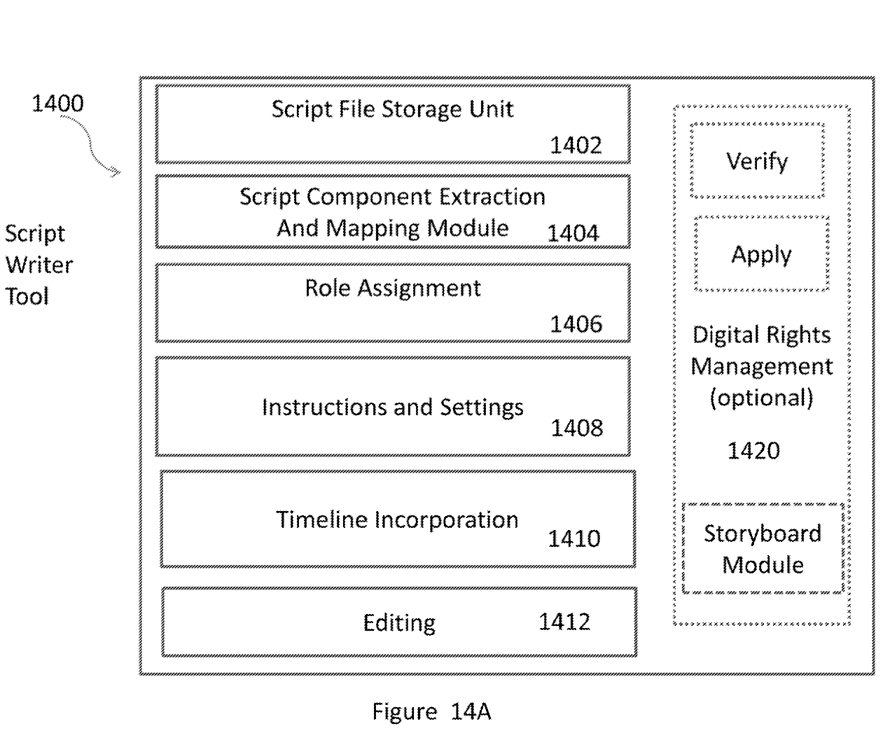

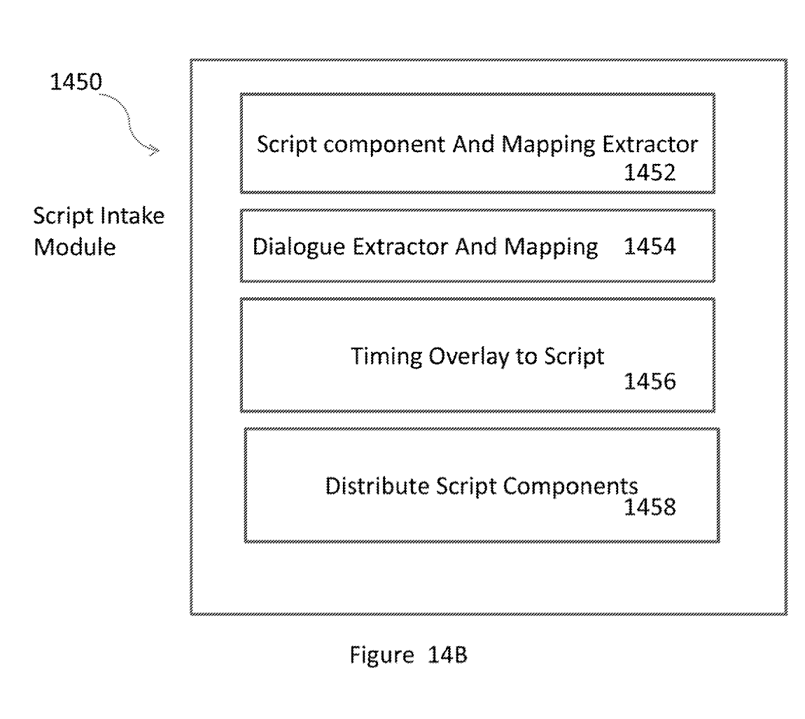

FIG. 14A illustrates a script writer tool 1400 that includes modules for script file storage 1402, script component extraction and mapping module 1404, character selection and role assignment 1406, instructions and settings 1408, timeline incorporation of the script components 1410 and editing the script 1412. The character selection includes both the original character creation as well as assignment of that character to a participant. The scenes may be a collection of video shots, or master created scenes. The scene may specify the background, descriptions and flavor of the scene. Technical directions may include the shots to take for a given scene and sequence, as well as camera angles, lighting specifics, and so forth. The script writer tool 1400 allows the master and other participants to add commands and comments to the various scenes, characters and other instructions. Authenticated users may access the script in a file format.

The script writer tool 1400 is used to create, edit, and modify the components of a script, such as action, command, and dialogue. The action describes the scene and motions, the command provides further instructions, while the dialogue provides the lines the characters speak. In one embodiment, the dialogue is provided on the scene for adding in audio after filming, such as karaoke videos.

The script writer tool 1400 enables the script writer to format according to multiple aspects, such as to adjust the typeface/font, line spacing and type area, language, as well as to specify the page per minute of screen time. This enables the script writer to adjust the script according to venue, such as for an American or European movie. The script writer may further edit according to prose, such as to focus on audible and visual elements. The prose selected by the script writer will provide explanations for the participants.

The script writer tool 1400 may further include a storyboarding module to enable the script writer to develop a story line which can be translated into the final video scenes. The storyboard module may start with an editable template that enables the user to quickly build a story line, such as to have drag and drop features, people, actions, and scenes. The storyboard module may be useful in creating an animated portion of a movie or an entire animated movie.

In one embodiment, the script writer tool 1400 includes a digital rights management module, 1420 which may incorporate multiple modules. A first module may be used to verify the material incorporated into the script is not infringing the copyrighted material of others, such as to compare to a database external to the script writer tool 1400. A second module may be used to apply a Digital Rights Management (DRM) security mechanism, such as encryption or other means.

The script file storage unit 1402 stores the script created and uploaded by a writer, director or other with privileges allowing inputs to the script. The script file may be edited by multiple authorized collaborators. Each script includes a variety of components, such as characters, scenes, actions, background, music and audio information and so forth. The script component extraction module 1404 identifies these components in the script file and uses this information to identify the roles that will be used to prepare the video film project. For example, the script component extraction module 1404 identifies a character, and then enables the director or casting director to select a collaborator to fill this role. The selected collaborator, or actor, is then given privileges which allow the collaborator to access the script, the characters lines, definition and actions, as well as to upload their contributions. In this example, the actor's contribution may be a video of the actor acting out their lines. The script component extraction module 1404 identifies the time when the actor's lines are to occur in the video project.

The script component extraction module 1404 creates various files for the components of the script file. These files are then used to compile the contributions of the various contributors into a final product. The script component extraction module 1404 works in coordination with the timeline incorporation module 1410, which receives the contributions of the collaborators and incorporates them into the timeline. In this way the script provides the plan for the video project. The components include characters, instructions, settings, and definitions, wherein the collaborators use the components to create their contributions. The received contributions are then implemented into the video project.

The script writer tool 1400 enables collaborators to edit the script, when the collaborator has editing privileges. The editing module 1412 enables such editing of the script file. There are a variety of ways for multiple collaborators to edit the script. In a first embodiment, the collaborator edits are identified as changes to the script. The director may accept or reject the edits. The edits may be presented to multiple collaborators for group acceptance and discussion. Once accepted, the edits become part of the script.

FIG. 14B illustrates an embodiment of a script intake module 1450 which receives the script creations and components from the script writer tool 1400 and extracts information from the script for distribution throughout the collaborators. This enables each participant to provide their portion of the movie while understanding the context and other components of the production. The script intake module 1450 includes a script component extractor 1452 and a dialogue extractor 1454, which extracts the characters and dialogue from the script. These components are stored accordingly and role assignments are applied. For example, a main character is associated with that character's scenes and lines in the script. The participant selected as the main character will be authorized to access this information. The actor will further be able to upload their video and audio portions. A module 1456 applies the timing overlay to the script, by coordinating the script to the timeline. The script intake module 1450 further distributes the script components, such as lines, timing, technical features, and so forth to the collaborators.

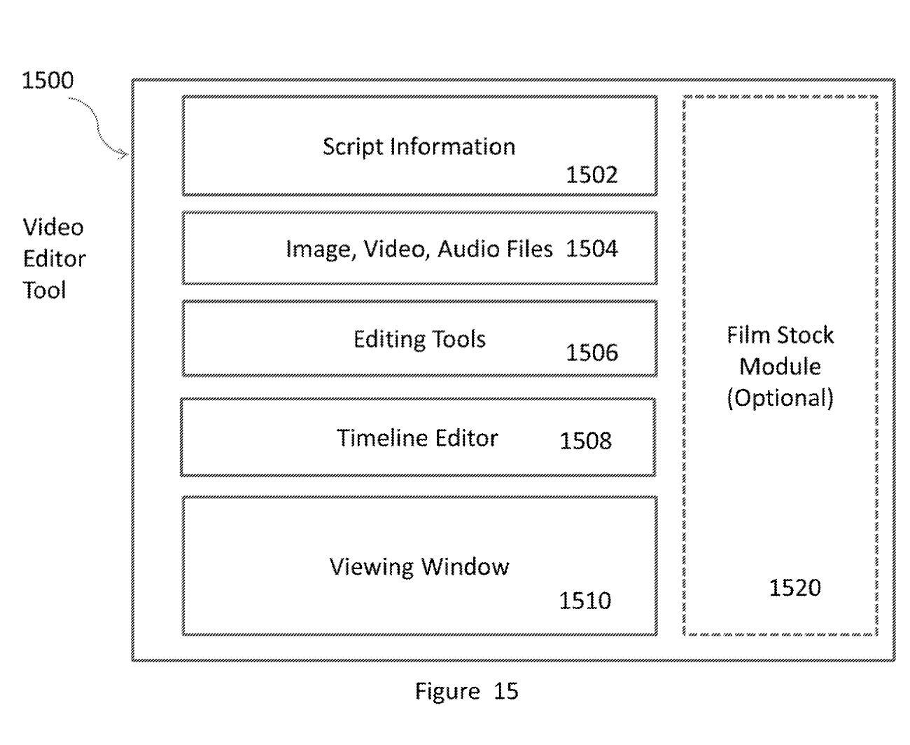

The system adds the results of the script writer tool 1400 to the video production environment, and adds scenes, shots, and characters to the video production page. FIG. 15 illustrates a video editor 1500, having modules for script and related information 1502, image, video and audio file handling 1504, editing tools 1506, timeline editor 1508, and video viewing window 1510. A user may select a scene from the video production page to edit shots and to assemble the scene. The user may add transitions between scenes. The final video is rendered to its original video quality after all scenes are successfully assembled. An optional film stock module 1520 may be included to access film stock available either freely or for fee. Such film stock may be incorporated into the movie.

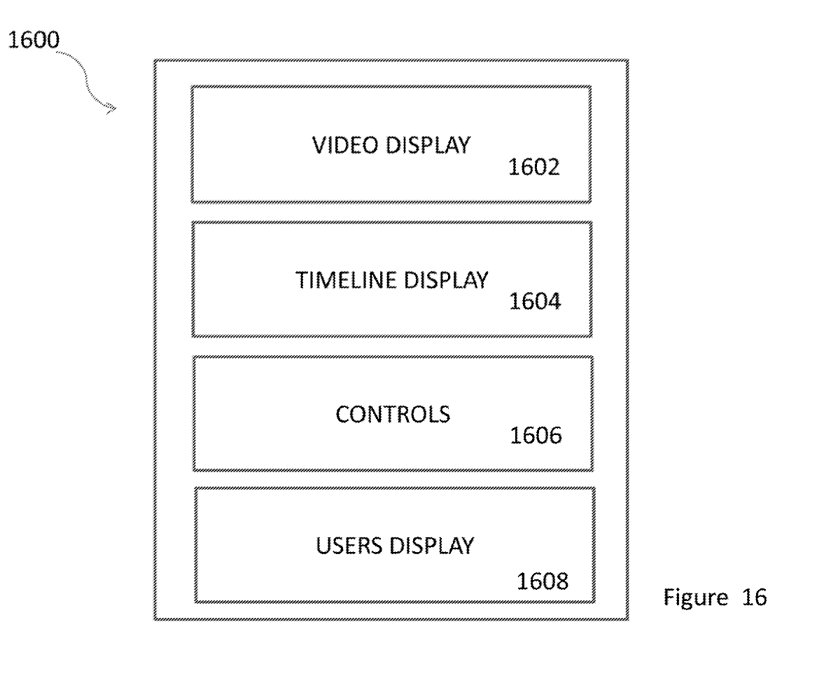

As social media and mobile applications have exploded with the introduction of ever smarter smart phones, the present techniques of merging script information with video/audio project information in a collaborative environment is particularly vital. FIG. 16 illustrates a mobile device display screen 1600. The mobile application for the collaborative video production product provides a video display portion 1602, timeline portion 1604 which corresponds to the video displayed, and a control portion 1606. The control portion 1606 may include a variety of controls, from drag and drop instructions that allow the user to edit the video by dragging control elements to the video to social network interfaces that allow sharing of the video editing real time. In one scenario the video or multimedia project is displayed for multiple users in real time. The collaborators may discuss the video using their mobile devices, or one or more collaborators may be using their PC or other computing or mobile device. In one embodiment a user having a mobile e-reader may send script or other information to other users from the e-reader. Some mobile devices have capability to perform readability and other statistical calculations, which may be performed on the video project and then provided as feedback to other users. Still other embodiments may provide analysis and use information which may be used to refine the video project, or to identify advertisers, in one embodiment, the collaborators access a third party service which identifies images in the video project and match these to brands and products. This information may be used to procure advertising revenue from these companies. Still further, the mobile application may connect to social media allowing easy upload and presentation on. Internet and other applications. The collaborators may solicit feedback and suggestions from viewers to refine and improve the video. The mobile application may store the video project and associated data in a cloud environment, where multiple collaborators can access and edit the project.

In one embodiment templates are provided on which a multimedia production may be built, such as for a horror movie, the various scene selections may be provided as well as character information, scary voices and noises, as well as links to information on this genre. Users may also build templates, such as for a series of movies or productions with a common theme, such as a science series. Educators may use the collaborative system to build projects with students, where the educator enters the script information, which may narrative or text book scripting such as for a documentary, and students access this information and add to the project. The end result is a multimedia presentation illustrating concepts learned.

Sports casters may use such a system to incorporate footage taken by local photographers and incorporate into nationwide or worldwide video feeds, and other projects. The sports caster provides a script identifying the information desired for the video or sports cast, identifying specific views from specific locations, footage of specific teams and players, and so forth, wherein the sports casters send out a request of participants. As local participants respond, they are able to send their video footage to the sports caster specifically identifying which information they are providing. The sports caster does not have to go through the videos to manually position in the film, but they are already marked according to their location on the timeline according to the script. The editor then merely watches the films to select the one desired.

### Partnership-Based Revenue

When movie fans, amateurs, want-to-be actors, cameramen, directors, editors, special effects, artists, musicians, and so forth, all join forces to create their own video production with unlimited freedom, a whole new generation of video content emerge. By including interaction with script writers during the production process, the script is seamlessly embedded into the video editor to balance tasks among production team. The outcome is a diverse and global user community that includes students, writers, actors, cameramen, artists, filmmakers, musicians, educators, journalists, travelers, activists, sports enthusiasts, and bloggers basically anyone who wants to create original video content. A variety of new types of partnership-based revenue are enabled by this novel collaborative online video production system. Actor Kit Vendors, such as companies selling Video camcorders, green/blue screens, external microphones, and Lighting, may use the collaborative system to enable sale of their goods. Advertisers may advertise on the system for consumer goods, media sites, movie & TV releases, and events, specifically targeted at the video creators and may advertise on the resultant video. Service Providers may include talent agencies, talent coaches, art schools & programs. Industry Productions may create commercial videos, host best video competitions, as well as to provide advertisements, announcements, tutorials, training materials, news feeds, and travel videos. Cable networks may license such application to produce its video ads and content.

### On-Location Hubs

Some videos require special effects, precise synchronization, and video layering techniques during production. In particular, some will require background screen removal, such as the use of chromakey screen techniques, to enable video layering. Since this is a specialized feature not available to general web application users, on-location Hubs augmented with special equipment, services, and connectivity are deployed to assist users lacking such tools. For instance, some actors and cameraman may not have chromakey screen, proper lighting equipment, wireless microphone, or cameras. Hence, they can visit these Hubs to shoot and upload these scenes. A variety of possible Hub features and functionality are described for clarity.
Hub Location Finder—A Collaborative Video Production Web application having a location finder, which provides a “Locate Hub” tab. This feature allows users to locate a nearby Hub to enable functionality that the user may not have. This may include special camera equipment, background screens, dramatic effects, stunts, and so forth and may enable the user to shoot and upload video with minimal investment.
Hub Scheduling Module—A Hub scheduling module enables users to reserve time to visit based on their schedule, production timeline, associated productions and so forth.
Hub Payment Module—A payment module allows users to pay for their reserved time, and may enable fee sharing for use of the Hubs by users, production owners, advertisers, and so forth.
Cloud Upload Module—During video shooting session at the Hub, Productions are uploaded in order for users to access the roles, lines, lyrics, tasks, action, and comments assigned to them.
Hub Set Features—A Hub includes background screens, such as chromakey screen, camera(s), lighting, adjustable mounts, microphones, speakers, projection screen, and other tools necessary during video shoots. A controller manages the features, allowing modification, adjustment, and flexibility for the video production.
Production Parameter Extraction—A Hub is connected to the cloud to extract production parameters associated with the productions assigned to users. Such parameters include camera and lighting angles, distance from object, video resolution, aspect ratios, and other parameters.
Collaborative Content—Collaborative content available for users to access from the cloud, such as to view the screenplay lines, storyline, lyrics, or other characters' assets included in the same scene before, after, or during video shoot to make users' experience more enjoyable.
Hub Quality Module—The Hub system may verify video quality and its compliance with the script before indicating to the user that the session is over. For instance, sound quality check, chromakey screen editing tools, and video layering with other videos in the same scene can be checked during the session to guarantee that uploaded videos is in compliance and of highest quality.
Contests—in the case of a contest, such as an “American Idol”-like talent contest, the music is automatically overlaid on top of video to produce the video song. Lyrics are displayed during the video shooting session to further assist users; in this case they are considered signers. The contestant's voice may then be added to other voices and instruments to better judge the talent.
Cloud Storage—The Hub system allows users to upload all or a portion of their videos to the cloud for further processing by Video Production members, such as the editor.
Casting Module—Collaborators may connect through a social network or casting site, in a type of casting call, and agree to meet at the Hub for production. The casting call may send out message having a respond by date. The requester may send a script and ask each one to audition for parts. The Hub may then analyze each of the auditions against predefined criteria and suggest participants to the producer.
Social Networks—Collaborators may use social networks and other sites to get advice and help with challenges/problems. The Hub may connect to such sites, enabling a user the option of connecting, or accessing the questions and solutions of previous users. The Hub uses feedback from the various social networks and other sites to adapt to and anticipate the current and future desires of production collaborators.
Advertising Module—Local stores and services may provide advertising through the Hub, such as for example an acting coach, piano teacher, voice trainer, dance instructor, and so forth, in some embodiments, the Hub may be funded by such advertising. Where the Hub is located in a mall having a variety of shops, the advertising may be sent to a mobile device in proximity of the Hub. Further, the Hub may also advertise to those in close proximity to the Hub, inviting them to visit the Hub and join a collaborative production. In some embodiments the Hub has an associated API with which vendors and service providers may integrate their businesses to provide advertising at the Hub or to Hub users.

### Mobile Devices

With the increase in functionality and the refinement of mobile devices as video production tools, the mobile device is a viable tool in these collaborative productions. The mobile device may be a cell phone, a laptop computing device, a tablet device, a camera, or other device having communication capabilities with the cloud, the Hub, and/or other collaborator devices. As computation and management of the production environment(s) and project may be positioned in the cloud or at a server, the software required by the mobile device is minimal and may be modified as needed through Internet and/or over-the-air communications.

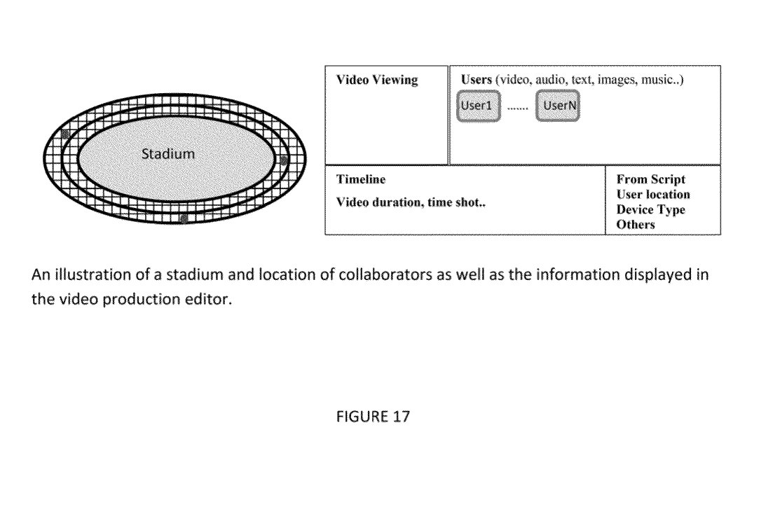

When videos or other video production assets and files are uploaded from a mobile device, the location, time, event or occasion, and type of mobile device may be included. For example, viewers of a sporting event who subscribe to its online video production are responsible to cover the event from their location by recording and automatically uploading videos captured during the event based on their location, recorded time, type of mobile device, and others as seen in FIG. 17. In the example illustrated, several users are positioned throughout a stadium, each having a different view of the event. The participants may also communicate real-time during the event, such as announcers; however, these participants are not together in one place, but rather distributed. The videos are captured from mobile devices, and uploaded to the cloud, where other participants/collaborators may access the data. Other specialized videos are those associated with educational course, training session, product demonstration, entertainment live show, and others.

The mobile device may be used to store a wide variety of information about user preferences, connections, networks, interests, shopping and wish lists, and so forth. This information may be used via the mobile device or may be integrated with the Hub to enable advertising. A module may combine such personal preferences and information to identify and suggest combinations of video content, back grounds, and other content that may be used in a video. For example, if the user likes a particular brand of purse these may be added to the video. Similarly, if the user has some photos from a trip to Italy, these may be suggested as a background for scenes in a video. The Hub and mobile may enable the collaborative production system to compile and analyze this information, and provide recommendations based on this historical information. For example, the system may store the statistics on each production, including time to produce, genre, products used as stage dress and props, success of the production, which may be based on any of a variety of criteria, such as subscribers, downloads, views, advertising revenue, and so forth. The success of a production may be further analyzed to identify success factors which contributed to the success. These success factors may then be used to recommend formats, products, advertisers, and so forth. Still further, the success factors may identify genres, audiences, actors, acting styles, techniques, locations, and other factors which will lead to success. The system may recommend a combination of success factors, and may indicate which factors do not work well together, for example New York accents in a cowboy film. The success factors may consider external factors as well, such as critical reviews of theater films.

### Screen Tests, Auditions and Rehearsals

The collaborative production system and the Hub allows a producer to schedule screen tests, auditions, rehearsals and other events at the Hub without attending in person. The video components are configured according to the screen test scene, so that each actor trying out for a role may be considered as close to the actual scene as possible. The producer or casting director may interact with actor via communication set up at the Hub. The screen test is uploaded to the cloud, where the producer may interact and enhance or modify digitally. In some embodiments, the number of cameras, the camera configuration, the camera angles, and so forth may be adjusted remotely by the producer. In some embodiments multiple actors may take the screen test or audition, or may rehearse, from distributed Hub locations or combinations of Hub and other non-Hub locations concurrently. This distributed production system enables efficiencies and may be used to avoid delays associated with set change and so forth. The control module for such interactions may be resident at the producer's location, in the cloud, on a dedicated server or other location. Still further, the control module may be distributed among multiple computing devices. An API may enable individual modules to integrate with the control module, such as a specific control module at the Hub or developed by a collaborative group.

### Business Videos

This includes investment pitches, company overview, market coverage, product or service description, promotional, explainer, testimonial, and how it works. For instance, a company selling a home appliance may produce a testimonial video where the Characters in the Script are customers or partners sharing their experience using such appliance in different ways. Company may base such a production on a contest or decide to compensate selected contributors.

Companies often develop internal videos and presentations for compliance training, safety training, software and tools training, as well as professional development videos. Currently these videos are costly as most companies use external services to prepare the videos. To keep current, and to personalize the content to the company, the collaborative web video production environment of the present invention allows the company to produce videos internally using applications, scenarios, tools and system architectures. These may be produced by the subject matter experts, allowing greater clarity and coordination with the company goals. The company may choose not to build all of the video themselves, but rather may use stock video backgrounds, transitions and other features available for use in a collaborative environment. Similarly, the company may participate in an ecosystem which extends beyond the company, and allows collaboration with others, similar to open source environment projects. These ecosystems may be organized in a variety of ways, including a pay-per-use model, a subscription model, or a use model that incurs licensing obligations on use. In one embodiment, the configuration of information in the collaborative web production environment enables a user to participate in a variety of these models, which prohibiting others. Different encryption schemes may be applied to the various models. When the user uses information from different sources, a monitoring module stores this information to identify the source, the licensing specifics and the communication/encryption mechanism implemented. The control module for such interactions may be resident at one location, in the cloud, on a dedicated server or other location. Still further, the control module may be distributed among multiple computing devices. An API may enable individual modules to integrate with the control module, such as a specific control module at the Hub or developed by a collaborative group.

### Music Videos

This could be collaborative video production when singer is shooting his song while the music track is bring streamed from the cloud for optimal synchronization. Special effects, background videos and images, or other videos such as dancers are layered during editing process. Another application is music video similar to those we see on American Idol. Singers produce their auditions or contests videos by laying their singing video with the song music. Songs music and lyrics may be located in one or more application libraries. The control module for such interactions may be resident at one location, in the cloud, on a dedicated server or other location. Still further, the control module may be distributed among multiple computing devices. An API may enable individual modules to integrate with the control module, such as a specific control module at the Hub or developed by a collaborative group.

### Educational Videos

Instructors collaborate on a specific topic to teach the material collectively. The characters in the script, or storyline, are the instructors, students, and other contributors such as lab assistance demonstrating a lab experiment. The students may collaborate on the script, content and effects so as to enable the instructor to prepare more effective videos. Teachers of this course worldwide may collaborate on content and their experiences as to effective educational tools. Teachers in ethnic neighborhoods may collaborate with educators from the origin areas of the students, providing better content and teaching techniques for student comprehension. The script may be built on the course text book, where the content module compares the script text to the text book and identify concepts, keywords and figures which were not included or are inconsistent with the text book. The content module may also map script content to the pages or portions of the text book discussing that portion. Similarly, the video may have video hyperlinks that direct to other video content. The video hyperlinks may launch a website or may be embedded video that is used to enhance the script. In one example, the video hyperlinks works in parallel with the script and video to illustrate a real world example, such as where a geology course video that includes animations of a geological event and the video hyperlink overlays an actual filmed footage of a real geologic event. The control module for such interactions may be resident at one location, in the cloud, on a dedicated server or other location. Still further, the control module may be distributed among multiple computing devices. An API may enable individual modules to integrate with the control module, such as a specific control module at the Hub or developed by a collaborative group, nature publication group, educational group, consulting group or other feature or service provider.

### Cooking Videos

Characters in this video are cooks from across the globe collaborating on as specific dish. For example, if the target dish is about cooking Thanksgiving Meal then alternative recipes and cooking methods are shared from across the nation. Furthermore, in some instances advertisers or vendors sponsoring or producing the video may want to share the links or location of nearby stores where some of the ingredients can be purchased or final meal can be ordered. Advertisers may desire to have a video of the cook directing viewers to their store or products. This could be achieved with a video hyperlink to such a video, wherein the video hyperlink pauses the cooling video and injects the advertising video. The control module for such interactions may be resident at one location, in the cloud, on a dedicated server or other location. Still further, the control module may be distributed among multiple computing devices. An API may enable individual modules to integrate with the control module, such as a specific control module at the Hub or developed by a collaborative group.

### Commercial or Infomercial Videos

These are similar to Business Videos with the addition of special deals, pricing, and demonstrations or testimonials from variety of users. Advertising is a costly part of doing business, and some of the most effective advertising is internet multimedia content. Companies that desire to build an advertisement or other multimedia content for the internet, television, or other outlet, may use the collaborative web production environment to build videos in a timely manner, with full control of content. Each step in the process may include one or multiple collaborators. The script or other portions of the video production may be provided by collaborators. The editing and revision may be done by a group of collaborators. Combining the collaborative aspects allows the advertiser quickly review different versions, combinations and scenes. A translation module may be used to translate the content into multiple languages worldwide, where local collaborators may provide feedback as to any country or area specifics that should be incorporated into the video. For example, in one country testimonials are desirable, while in another country statistics and data result in increased sales. In translation and local implementation, the ability to link the script to the video production content enables collaborators in each country to follow the meaning of the script and determine if the visual aspects, music and actors are appropriate for advertising in their country. The control module for such interactions may be resident at one location, in the cloud, on a dedicated server or other location. Still further, the control module may be distributed among multiple computing devices. An API may enable individual modules to integrate with the control module, such as a specific control module at the Hub or developed by a collaborative group.

In some embodiments the Hub location is used to generate the video, wherein the response to the broadcast may be evaluated real-time to make adjustments and changes to the production. For example, where an advertising campaign uses certain terminology that is found uninspiring, the producer may change, delete, edit that portion of the production and push it out to the broadcasters minimizing delay.

### Gaming

The collaborative environment may be used to build gaming modules where content is desired from subject matter experts, such as military or other. The gaming module receives the contributions and determines the configuration of the game. The gaming script has many directions, where from a given decision point, there may be multiple scripts. The script in this sense encompasses the visual landscape that the user will see. Collaborators may provide suggested angles, structures and logistics for a given game. These elements are then compiled along the script timeline.

Video gaming often repeats the same series of scenarios, where players learn from previous decisions and routes how to increase their gain in the game. In the first person shooter games, the player's character moves through the various buildings, war zones, and so forth, each time learning where to avoid, where to engage with others, how to hold their weapons, when to shoat, and so forth. Players like to share their victories by uploading to on-line video broadcast sites or sending each other recordings of their play. Players enjoy collaborating on strategies, playing together and anticipating other players. Collaborators may incorporate elements of a video game as the scene for a video production. The collaborators may incorporate recorded video from an instance of game play that they find interesting or desirable for the collaborative work.

### Animation and Voice Over Applications

The collaborative environment is particularly desirable for voice over during an animation, as the script identifies the location of the voice content. Further, a module enables collaboration of animation effects and voice tied to the script time line.

### Use of Templates

In some instances, video production templates are made available to users you wish to get a jump-start with their production. Users can select or search for appropriate template based on but not limited to target application and audience, genre, duration, number and type of characters, locations, scenes, and shots. Users are also able to mix and match between templates to customize their own template. Additional fees and services are applied to use these templates. The following describes some of example features and functionalities enabled by such templates.
The initial script is drafted.
Pre-loaded related videos, audio, and image files are uploaded to the user video production media library.
Potential collaborators are selected from the end-to-end cloud video production database. Such collaborators are pre-screened and selected. Fees to both production owner and collaborators may apply for this additional service.
For corporate internal use:
   Collaborators consist of employees and contractors and templates
   Medial library includes searchable company video, audio, image files
   Video templates include marketing, educational, training, executive, and other related video projects.
The ultimate goal of the script integration with collaboration and video editor is to make video creation, update, and production process as simple as creating and updating PowerPoint slides in order to enable every PowerPoint user to seamlessly transition to Videos.

### Operation with Enhanced Hardware

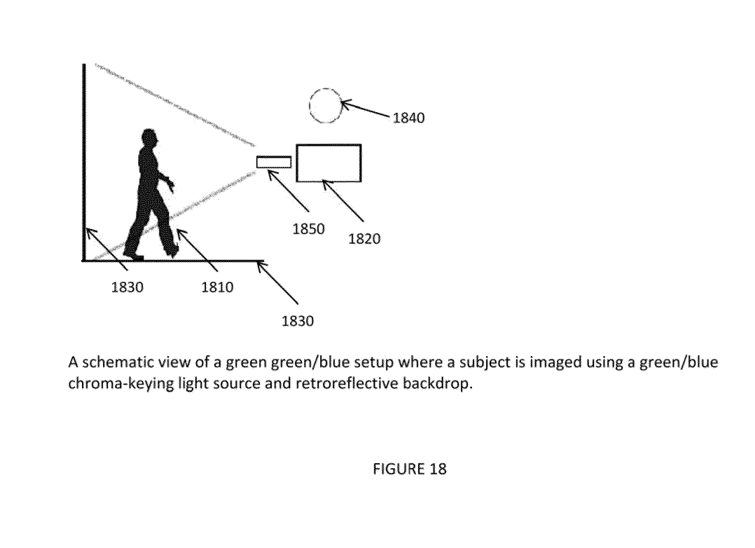

Users who are assigned with the task of shooting the videos, capturing audio, or images may require enhanced hardware to further improve video quality. For instance:
Current mobile devices are not equipped with optimal audio capturing microphones and technologies and hence, hence an audio hardware that is connected via cable or wirelessly to the mobile device is used to enhance audio quality. Such external audio device may be controlled by remote collaborators via the Internet and mobile network.
Lighting may be poor in the location where users want to shoot videos. Pop-up reflective screens or powerful bright light equipped in mobile devices, connected to them, or operate on a stand-alone basis are used. Such external lighting devices may be controlled by remote collaborators via the Internet and mobile network.
Chromakey screen with its necessary lighting may not be available. Furthermore, Light-Emitted-Diode (LED) illuminated retro-reflective backdrops may be too expensive for some users or complex to operate. In a typical application of a retroreflective backdrop: as illustrated in FIG. 18, a character 1810 is imaged by a camera 1820 against a retroreflective backdrop 1830 which extends both generally vertically and generally horizontally. The presenter 1810 and the backdrop 1830 are generally illuminated by sources of light 1840 and 1850, respectively, where 1850 is a chroma-keying light source which may comprise one or more LEDs emitting blue or green light for example.

### Retroreflective Backdrop Comprising Glass Beads and Chromakey Paint

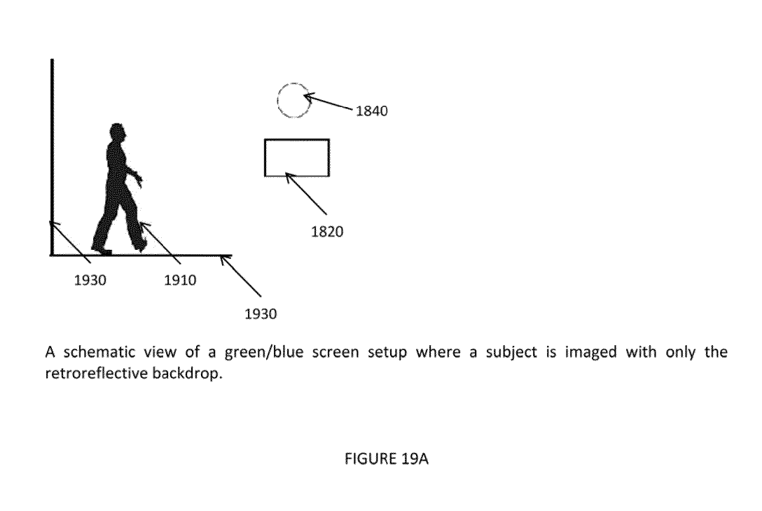

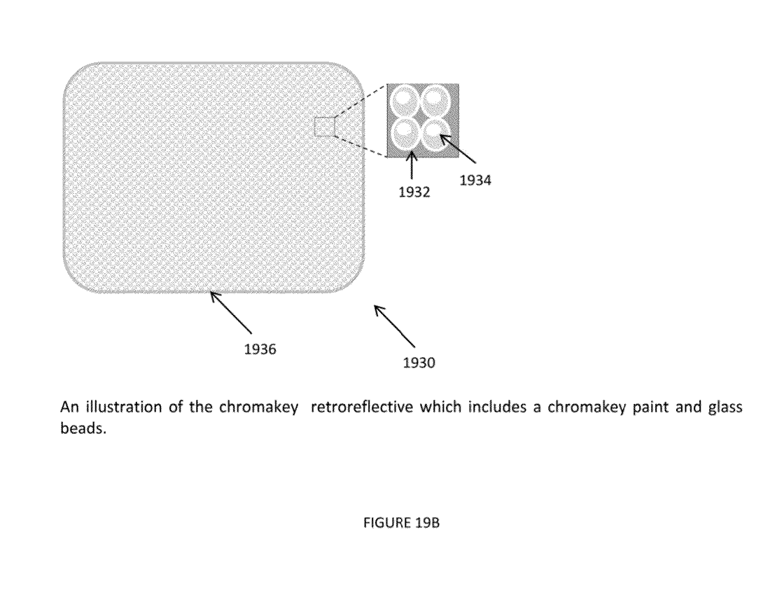

In one embodiment (FIG. 19) of an enhanced hardware, the retroreflective backdrop 1930 includes the chromakey paint 1932 and glass beads 1934, as illustrated in FIG. 19b, in order to eliminate the need of the chromakey lighting 1850 as illustrated in FIG. 18. One way of building the chromakey retroreflective backdrop is the paint a flat surface with the chromakey paint or one that includes glue percentage. Then, the glass beads are gently poured over the surface and then the surface is flipped upside down once the paint is completely dry.

### CONCLUSION

While various DPM and CRU configurations and elements are illustrated and various apparatuses are configured in accordance with one or more features described in this disclosure, it is understood that many modifications and variations may be devised given the above description. The embodiments and examples set forth herein are presented so as to explain the present invention and its practical application and to thereby enable those skilled in the art to make and utilize the invention. However, those skilled in the art will recognize that the foregoing description and examples have been presented for the purpose of illustration and example only. The description set forth is not intended to be exhaustive or to limit the invention to the precise form disclosed Many modifications and variations are possible in light of the above teaching without departing from the spirit and scope of the following claims.

What is claimed is:

1. A method for creating a video project by collaborators using a plurality computing devices, comprising:
broadcasting an announcement of an event;
generating a screenplay script data file, the screenplay script data file having a plurality of screenplay script elements related to the event;
identifying at least one of the plurality of screenplay script elements;
script dicing the screenplay script data file to obtain at least one diced element;
assigning roles to collaborators for the event based on the screenplay script data file;
generating media files for the collaborators in their roles for the event, where the media files include data to be displayed along a video in a video editor timeline;
accepting participants requests to participate in the video project;
monitoring the video project and providing instructions to collaborators;
authorizing each accepted participant for their task in creating the video project; and
assembling the video project with portions provided by the participants of the video project.

2. The method as in claim 1, wherein at least one of the plurality of computing devices includes a mobile device.

3. The method as in claim 1, wherein the collaborators further include event attendees or participants.

4. The method as in claim 1, wherein scenes and video shots are assigned to collaborators based on at least one of: the collaborator's location, a viewing angle, and time.

5. The method as in claim 1, wherein Application Programming interfaces are used to integrate with internal or external software and hardware devices.

6. The method as in claim 1, further comprising providing a template for at least one function in generation of the video project, wherein the template specifies information and roles that are to be assigned.

7. The method in claim 1, further comprising receiving advertisement content for distribution to users at a Hub location.

8. The method as in claim 1, further comprising calculating fees for collaborators according to a predetermined compensation model, wherein the fees are calculated based on role, and type of video production.

9. The method as in claim 1, wherein throughout the video project prompts are placed for advertisers products or services, the method further comprising:
sending an offer to access information about a product or service; and
receiving a request to access the information.

10. A distributed video production system, comprising:
a central storage device;
a central controlling device;
at least one video production Hub site to provide video production inputs to the central storage device, the at least one video production Hub site incorporating a hub location finder module, a hub scheduling module, a hub payment module, a cloud upload module, a hub quality module, cloud storage module, a casting module, and an advertising module.
